(19) United States
(12) Patent Application Publication
(10) Pub. No.: US 2019/0224929 A1
(43) Pub. Date: Jul. 25, 2019

(54) WOOD PULP FIBER- OR CELLULOSE FILAMENT-REINFORCED BULK MOLDING COMPOUNDS, COMPOSITES, COMPOSITIONS AND METHODS FOR PREPARATION THEREOF

(71) Applicant: FPINNOVATIONS, Pointe-Claire, CA (US)

(72) Inventors: Otman OULANTI, Montréal (CA); Makhlouf LALEG, Pointe-Claire (CA); Danielle GAGNÉ, Pierrefonds (CA); Norayr GURNAGUL, Saint-Hubert (CA); Josée DESMEULES, Montréal (CA)

(21) Appl. No.: 16/312,998

(22) PCT Filed: Jun. 21, 2017
(86) PCT No.: PCT/CA2017/050758

§ 371 Date: Dec. 21, 2018

Related U.S. Application Data
(60) Provisional application No. 62/353,943, filed on Jun. 23, 2016.

(51) Int. Cl. B29C 70/46; B29C 70/12

(52) U.S. Cl. CPC B29C 70/46; C08J 3/203; B29C 70/12

(57) ABSTRACT

The present disclosure relates to wood pulp fiber- or cellulose filament-reinforced bulk molding compounds, composites, compositions and methods for preparation thereof. The composition comprises a resin; about 0.5 to about 15 wt. % of a 5 cellulosic reinforcement wherein the cellulosic reinforcement is chosen from wood-pulp fibers, cellulose filaments (CF) and a mixture thereof; and about 30 to about 65 wt. % of a filler.

### CROSS-REFERENCE TO RELATED APPLICATIONS

The present application claims the benefit of priority from co-pending U.S. provisional application No. 62/353,943 filed on Jun. 23, 2016, that is incorporated herein by reference in their entirety.

### FIELD OF THE DISCLOSURE

The present disclosure relates to bulk molding compound (BMC) and more particularly wood pulp fiber-reinforced and cellulose filament (CF) reinforced BMC.

### BACKGROUND OF THE DISCLOSURE

Bulk molding compound (BMC) is a ready to mold material, mainly a glass fiber-reinforced polyester resin material primarily used in injection molding, transfer molding and compression molding. The BMC consists of a mixture of resin, fibers, fillers, thickening agent and other additives. The fibers can be chosen from for example wood pulp fiber, natural fiber, aramid and carbon fibers. The BMC resin is a thermosetting resin, generally unsaturated polyester (UPE) or vinyl ester (VE) resin. However, any thermoset resin that can undergo a thickening process is suitable for the BMC process. The compound undergoes a maturation step under controlled humidity and temperature for about 1 to about 4 days. The thickening process is a critical aspect of the production process of BMC. The latter is responsible for increasing the compound viscosity to obtain a tack-free material that is easy to handle, thus ensuring a good and uniform flow under heat and pressure to fill out the mold cavities during the molding process and preventing phase separation between resin and fibers.

The reinforcing fibers normally used for BMC consist of chopped glass fibers of ⅛ to ½ inch in length (Polymer Blends, Volume 2, D.R. Paul, Academic Press Inc (1978)). However wood pulp fibers, cellulose filaments, natural fibers, carbon or aramid fibers can also be used in BMC. The fiber loading in BMC is generally 10 to 30% by weight. The BMC resin is a thermosetting resin such as unsaturated polyester (UPE) or vinyl ester (VE) resin. The filler content in BMC is generally up to 65% by weight and is generally a combination of calcium carbonate and aluminum trihydrate (ATH). Fillers are used to reduce cost and also to impart specific properties such as fire retardancy which can represent up to 50% of the filler content in BMC. A high temperature activated curing agent is used to prevent any crosslinking at room temperature during compound production or maturation step. The produced compound is stored at low temperature during the maturation step. Other additives are also used in BMC such as mold release agent and low profile additives. The mold release is used to facilitate the removal from the mold. The low profile additives are mainly thermoplastic resins homogeneously dispersed in styrene suitable to reduce the thermosetting resin shrinkage.

The BMC is an economical material that can be formulated to provide high flame resistance, good dielectric properties and remarkable flow behavior during the molding cycle. These attributes make BMC a potential material for a wide variety of applications requiring non-structural mechanical performance and high dimensional stability. In addition, BMC can be processed by transfer molding or injection molding to produce complex parts for a variety of high volume applications in sectors such as automotive, building, construction, electrical and energy.

Increased environmental regulations have resulted in a growing interest to develop sustainable reinforcements in the composite industry. Bio-based fibers such as natural and wood pulp fibers and cellulose filaments are potential reinforcements for thermoset composites. Their specific strength, stiffness and high aspect ratio make the bio-based fibers suitable as reinforcing fibers. The incorporation of bio-based reinforcing fibers in composites presents several advantages for the composite industry. Bio-based fibers are an ecofriendly way to reduce the costs of parts and to lower their weight when compared to glass fiber composites, without compromising their specific strength. In addition, the production of fiberglass requires more energy to produce than natural and wood fibers. The latter fibers are also less abrasive than fiberglass fibers thus decrease tool and machinery damage associated with the use of computer numerically controlled milling or cutting machines. In addition, the bio-based reinforced composite present higher biodegradability compared to glass fibers.

Several studies have been conducted on incorporating bio-based fibers in thermoset composites but little has been published on the use of biofibers in BMC composites. The hydrophilic nature of wood and natural fibers characterized by a low water resistance and a lack of adhesion and compatibility with resins presents challenges for their use in composites. Focus has been made on the incorporation of untreated and treated natural fibers to improve their performance in composites. The main objective of these studies has been to evaluate the performance of natural fibers as a replacement for glass fibers in BMC.

In O. Owolabi et al., Journal of Applied Polymer Science, vol. 30, 1985, BMC composites were made from untreated and treated coconut fibers (at 1 mm length) by alkali-treatment (NaOH) and/or gamma-pre-irradiation. The reference BMC recipe comprises glass fibers (34 wt %), fillers (34 wt %), resin (25.5 wt %) and other additives (6.5 wt %). Three categories of BMC were manufactured in this study: a) fiberglass completely replaced by untreated or treated fibers with a fiber loading in BMC ranging from 17 to 38% by weight, b) fiberglass BMC composites made at similar fiber loadings and c) fiberglass in BMC reference recipe was partially replaced by untreated fibers at increasing concentrations ranging from 25 to 87.5%. The amount of filler in these composites ranged from 25 to 32% by weight. The resulting BMC composites made from natural fibers were lighter than fiberglass-based BMC. The untreated fiber-reinforced BMC samples had a lower modulus of elasticity, tensile and flexural strengths compared to fiberglass reinforced BMC. However when treated natural fibers (coconut) were used, flexural strength was significantly improved, exceeding that of fiberglass reinforced BMC.

UK patent application No. GB 2469181, entitled Hydrophobised Fibers and Their Uses, describes a treatment of natural fibers to make them more hydrophobic and suitable for reinforcing thermoset composites such as BMC. The hydrophobic treatment consisted of the reaction of a maleic anhydride group with cellulose. The natural fibers were mainly selected from agricultural fibers such as jute or fibers from recycled paper. The treated jute reinforced-BMC made by replacing fiberglass at a similar volume fraction (25%) and containing 25% (volume fraction) fillers had similar flexural properties to fiberglass reinforced BMC.

Moreover, in U.S. Pat. No. 5,767,177, entitled Injection Moldable Thermosetting Composition Especially for Motor Vehicle bodies, Methods of Production and Methods of Recycling, a specific BMC formulation was prepared from untreated natural fibers such as cotton or wood fibers combined with reinforcing fibers of high mechanical strength such as fiberglass (higher amount). The latter did not have a maturation step as for the regular BMC. The BMC comprised 5 to 15% by weight of cellulose fibers and 12.5 to 22.5% by weight of fiberglass. The filler content in this composition was around 20% less than regular BMC which consists of 50% filler. The resulting BMC had a higher flexural and impact strength but similar flexural modulus compared to BMC containing 18 wt % fiberglass. The untreated cotton fibers had good performance in BMC only if combined with fiberglass (higher amount).

### SUMMARY OF THE DISCLOSURE

Accordingly, there is provided in an aspect a composition comprising:
a resin;
about 0.5 to about 15 wt. % of a cellulosic reinforcement wherein the cellulosic reinforcement is chosen from wood-pulp fibers, cellulose filaments (CF) and a mixture thereof; and
about 30 to about 65 wt. % of a filler.

In accordance with another aspect there is provided a composition comprising:
a resin;
about 0.5 to about 15 wt. % of a cellulosic reinforcement, wherein the cellulosic reinforcement is chosen from wood-pulp fibers and cellulose filaments and a mixture thereof; and
a filler;
wherein the composition, when cured, has a density of less than about 1.85 g/cm³.

In accordance with another aspect there is provided a composition comprising:
a resin;
a cellulosic reinforcement, wherein said cellulosic reinforcement is chosen from wood-pulp fibers and cellulose filaments and a mixture thereof;
reinforcing fibers; and
about 35 to about 65 wt. % of a filler;
wherein said composition, when cured, has a density of less than about 1.85 g/cm³, and wherein said reinforcing fibers are in an amount lesser than an amount of said cellulosic reinforcement.

In yet another aspect there is provided a composition comprising:
a resin;
a cellulosic reinforcement, wherein the cellulosic reinforcement is chosen from wood-pulp fibers and cellulose filaments and a mixture thereof; and
about 30 to about 65 wt. % of a filler;
wherein the composition, when cured, has a density of less than about 1.85 g/cm³.

Another aspect herein provided is a composition comprising:
a resin;
about 0.5 to about 15 wt. % of a cellulosic reinforcement, wherein the cellulosic reinforcement is chosen from wood-pulp fibers, cellulose filaments and a mixture thereof; and
a filler;
wherein the composition, when cured, has a tensile strength of about 35 to about 55 MPa and/or a flexural modulus of about 7 to about 13 GPa.

Yet another aspect herein provided is a composition comprising:
a resin;
about 0.5 to about 15 wt. % of a cellulosic reinforcement, wherein the cellulosic reinforcement is chosen from wood-pulp fibers, cellulose filaments and a mixture thereof; and
a filler;
wherein the composition, when cured, has a water absorption of less than 0.4% at 1 day, at 23° C., according to ASTM D570-98 standard and/or a water absorption of less than 1% at day 7, at 23° C., according to ASTM D570-98 standard.

In accordance with another aspect there is provided a composition comprising:
a resin;
about 0.5 to about 15 wt. % of a cellulosic reinforcement, wherein said cellulosic reinforcement is chosen from wood-pulp fibers, cellulose filaments and a mixture thereof; and
a filler;
wherein said composition, when cured, has step-by-step and short time dielectric strength properties similar to commercial fibreglass based bulk molding compound.

In accordance with another aspect there is provided a composition comprising:
a resin;
about 0.5 to about 15 wt. % of a cellulosic reinforcement, wherein said cellulosic reinforcement is chosen from wood-pulp fibers, cellulose filaments and a mixture thereof; and
a filler;
wherein said composition, exhibits an appropriate flow capacity during transfer molding process.

In accordance with another aspect there is provided a composition comprising:
a resin;
about 0.5 to about 10 wt. % of a cellulosic reinforcement wherein the cellulosic reinforcement is chosen from wood-pulp fibers, cellulose filaments (CF) and a mixture thereof; and
about 35 to about 65 wt. % of a filler.

In accordance with another aspect there is provided a composition comprising:
a resin;
about 0.5 to about 10 wt. % of a cellulosic reinforcement, wherein the cellulosic reinforcement is chosen from wood-pulp fibers and cellulose filaments and a mixture thereof; and
a filler;
wherein the composition, when cured, has a density of less than about 1.85 g/cm³.

In yet another aspect there is provided a composition comprising:
a resin;
a cellulosic reinforcement, wherein the cellulosic reinforcement is chosen from wood-pulp fibers and cellulose filaments and a mixture thereof; and
about 35 to about 65 wt. % of a filler;
wherein the composition, when cured, has a density of less than about 1.85 g/cm³.

Another aspect herein provided is a composition comprising:
a resin;
about 0.5 to about 10 wt. % of a cellulosic reinforcement, wherein the cellulosic reinforcement is chosen from wood-pulp fibers, cellulose filaments and a mixture thereof; and
a filler;
wherein the composition, when cured, has a tensile strength of about 35 to about 55 MPa and/or a flexural modulus of about 7 to about 13 GPa.

Yet another aspect herein provided is a composition comprising:
a resin;
about 0.5 to about 10 wt. % of a cellulosic reinforcement, wherein the cellulosic reinforcement is chosen from wood-pulp fibers, cellulose filaments and a mixture thereof; and
a filler;
wherein the composition, when cured, has a water absorption of less than 0.4% at 1 day, at 23° C., according to ASTM D570-98 standard and/or a water absorption of less than 1% at day 7, at 23° C., according to ASTM D570-98 standard.

Also provided herein in another aspect is a method of using of the composition herein described, the method comprising placing the composition in a mold and subjecting the composition to heat and/or pressure.

In a further aspect, there is provided a method for manufacturing a composition as defined herein, comprising:
mixing together the resin with the cellulosic reinforcement to obtain a first mixture;
mixing together the first mixture with the filler to obtain a second mixture; and
optionally maturing the second mixture under conditions suitable for obtaining the composition.

In accordance with another aspect there is provided a method of manufacturing a BMC composite, comprising:
obtaining a composition as defined herein; and
submitting the composition to conditions suitable for curing the composition so as to obtain a BMC composite.

### BRIEF DESCRIPTION OF THE DRAWINGS

In the following drawings, which represent by way of example only, various embodiments of the disclosure:

FIG. 1 is a flow chart of BMC preparation;

FIG. 2 is an illustration of BMC composite manufacturing by compression molding process;

FIGS. 3A, 3B and 3C shows bar charts of the tensile stress (MPa) (FIG. 3A), flexural stress (MPa) (FIG. 3B) and the flexural modulus (GPa) (FIG. 3C) of various composites made from BMC. The weight % of fiberglass, wood pulp fiber or CF reinforcements used is also shown above each bar;

FIGS. 4A and 4B show cross-section images of NBSK-BMC (FIG. 4A) and of fiberglass BMC (FIG. 4B) using optical microscopy;

FIG. 5 shows a cross-section image of untreated wood pulp fibers in reinforced BMC using optical microscopy and

FIG. 6 shows images of cellulose reinforced-BMC 3D parts made by transfer molding process

### DETAILED DESCRIPTION OF THE DISCLOSURE

The present examples are provided in a non-limitative manner,

### I. Definitions

Unless otherwise indicated, the definitions and embodiments described in this and other sections are intended to be applicable to all embodiments and aspects of the present disclosure herein described for which they are suitable as would be understood by a person skilled in the art.

As used in the present disclosure, the singular forms “a”, “an” and “the” include plural references unless the content clearly dictates otherwise. For example, an embodiment including “a resin” should be understood to present certain aspects with one resin, or two or more additional resins.

In embodiments comprising an “additional” or “second” component, such as an additional or second resin, the second component as used herein is different from the other components or first component. A “third” component is different from the other, first, and second components, and further enumerated or “additional” components are similarly different.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps.

Terms of degree such as “about”, “approximately” and “similar” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The term “dielectric strength properties similar to commercial fibreglass based bulk molding compound” as used therein means that dielectric strength properties of the products of the present disclosure do not vary by more than 10% or not than 5% when compared to dielectric strength properties of commercial fibreglass based bulk molding compounds.

The terms “cellulose filaments” or “CF” and the like as used herein refer to filaments obtained from cellulose fibers having a high aspect ratio, for example, an average aspect ratio of at least about 200, for example, an average aspect ratio of from about 200 to about 5000, an average width in the nanometer range, for example, an average width of from about 30 nm to about 500 nm and an average length in the micrometer range or above, for example, an average length above about 10 μm, for example an average length of from about 200 μm to about 2 mm. Such cellulose filaments can be obtained, for example, from a process which uses mechanical means only, for example, the methods disclosed in US Patent Application Publication No. 2013/0017394 filed on Jan. 19, 2012. For example, such method produces cellulose filaments that can be free of chemical additives and free of derivatization using, for example, a conventional high consistency refiner operated at solid concentrations (or consistencies) of at least about 20 wt %. These strong cellulose filaments are, for example, under proper mixing conditions, re-dispersible in water or aqueous slurries such as aqueous slurries of fillers. For example, the cellulose fibers from which the cellulose filaments are obtained can be but are not limited to Kraft fibers such as Northern Bleached Softwood Kraft (NBSK), but other kinds of suitable fiber are also applicable, the selection of which can be made by a person skilled in the art.

The term “fillers” as used herein includes a single type of filler as well as including a combination of different fillers.

The term “fibers” as used herein includes a single type of fibers as well as including a combination of different fibers.

The term “reinforcing fibers” as used herein includes a single type of reinforcing fibers as well as including a combination of different reinforcing fibers.

The term “resin” as used herein includes a single type of resin as well as including a combination of different resins.

The term “additive” as used herein includes a single type of additive as well as including a combination of different additives.

As used herein, the term “composition” refers, for example, to a bulk molding compound (BMC). For example, the composition can be a cured or uncured composition. For example, the BMC can be a ready to mold, reinforced thermoset polymer material that can be used in injection molding, transfer molding or compression molding. For example, the BMC compound can be provided in bulk or logs.

As used herein, the term “cured composition” refers to a composition that has been subject to heat and/or pressure. For example, the term “cured composition” is also referred to as a BMC composite. For example, the curing process can be a molding process. For example, the curing process can be injection molding process, transfer molding process or compression molding process.

### II. Compositions, Uses and Methods of Preparation Thereof

The present disclosure relates to cellulose fiber-reinforced bulk molding compound (BMC) and more particularly to wood pulp fiber or cellulose filament-reinforced BMC. The disclosure concerns, for example, untreated wood pulp fiber or CF-reinforced BMC made from small amounts of reinforcements compared to regular BMC. This disclosure also relates to wood pulp fiber or CF-reinforced BMC with high filler content.

O. Owolabi et al, GB24691 and U.S. Pat. No. 576,717 have reported the use of natural fibers as reinforcements, focusing on a partial or complete replacement of glass fibers in regular BMC. Good performance with natural fiber-reinforced BMC's was only obtained under the following conditions: 1) complete replacement of glass fibers with pre-treated natural fibers at similar or higher amount (17 to 38% by weight) or 2) partial replacement of glass fibers with untreated natural fibers used as secondary reinforcing fibers (smaller amount) in combination with fiberglass (higher amount). All the natural fiber-reinforced BMC's reported contained 20 to 25 wt % of fillers which is lower than what is regularly used in BMC (about 50 wt %).

An aspect of this disclosure is, for example, a complete replacement of fiberglass in regular BMC at lower levels of fiber loading with untreated wood pulp fibers or cellulose filaments (CF). This disclosure is directed, for example, to producing a lighter, high-performance bio-based reinforced BMC with up to about 60% filler content by weight. This disclosure also concerns, for example, performing BMC composites made from untreated wood pulp fibers at low fiber loading and high filler content contrary to the reported studies (treated natural fiber at high fiber loading and low filler content).

For example, the composition comprises about 0.5 to about 15 wt. %, about 1 to about 15 wt. %, about 0.5 to about 10 wt. %, about 1 to about 8 wt. %, about 1 to about 10 wt. %, about 2 to about 7 wt. %, about 3 to about 6 wt. % or about 4 to about 5.5 wt. % of the cellulosic reinforcement.

For example, the cellulosic reinforcement comprises wood-pulp fibers.

For example, the cellulosic reinforcement comprises cellulose filaments.

For example, the composition comprises about 30 to about 70 wt. %, about 30 to about 65 wt. %, about 35 to about 65 wt. %, about 35 to about 60 wt. %, about 40 to about 65 wt. %, about 40 to about 60 wt. %, about 45 to about 65 wt. %, about 45 to about 60 wt. %, about 45 to about 55 wt. %, about 50 to about 65 wt. %, or about 45 to about 65 wt. % of the filler.

For example, the composition, when cured, has a density of less than about 1.85 g/cm³, less than about 1.80 g/cm³, less than about 1.75 g/cm³ or than about 1.70 g/cm³.

For example, the composition, when cured, has a tensile strength of about 35 to about 55 MPa or about 38 to about 50 MPa and/or a flexural modulus of about 7 to about 13 GPa or about 9 to about 13 GPa.

For example, the composition, when cured, has a water absorption of less than 0.4% at 1 day, at 23° C., according to ASTM D570-98 standard and/or a water absorption of less than 1% at day 7, at 23° C., according to ASTM D570-98 standard.

For example, the composition comprises about 0.5 to about 15 wt. %, about 1 to about 8 wt. %, about 2 to about 7 wt. %, about 3 to about 6 wt. % or about 4 to about 5.5 wt. % of the wood-pulp fibers.

The presently described untreated wood pulp fibers can be in the dry form, individually separated, fluffed, opened, or hammer milled. The fibers may be opened with high specific surface area therefore allowing higher fiber networking in the BMC compound. The fiber networks can induce good BMC compound viscosity even at low fiber loading. The present disclosure also relates to fiber-reinforced BMC compound (e.g. uncured composition) with good flowability (flow capacity) during molding process for parts manufacturing. The present disclosure relates also to fiber-reinforced BMC composites (e.g. cured composition) with improved dimensional stability.

Two different fiber opening methods can be used. In a first method, a fluffer or fiber opener is used for fibers that are disintegrated, pressed and dried previously. A second industrial opening fiber method can be used which comprises for example, and without limitation, using a hammer mill and a commercially available fluff pulp dry lap or bale pulp. A comparison of fiber-reinforced BMC composites made using the two opening methods shows that the resulting BMC's have similar performances.

Untreated wood pulp fibers used to produce bio-based BMC can be obtained from, but are not limited to, softwood kraft pulps such as NBSK (Northern Bleached Softwood Kraft), SBSK (Southern Bleached Softwood Kraft-Fluff pulp dry lap) or cellulose filaments made from NBSK. The wood pulp fibers are selected also from but not limited to hardwood pulps.

For example, the composition comprises untreated wood-pulp fibers.

For example, the composition comprises wood-pulp fibers in dry form.

For example, the composition comprises wood-pulp fibers that are individually separated, fluffed, opened and/or hammer milled.

For example, the composition comprises wood-pulp fibers that are chosen from softwood pulp and hardwood pulp.

For example, the composition comprises wood-pulp fibers that are softwood pulp chosen from Northern Bleached Softwood Kraft (NBSK), Southern Bleached Softwood Kraft (SBSK), thermomechanical pulp (TMP) and bleached chemi-thermomechanical pulp (BCTMP).

For example, the composition comprises about 0.5 to about 15 wt. %, about 1 to about 15 wt. %, about 0.5 to about 10 wt. %, about 0.5 to about 9 wt. %, about 1 to about 8 wt. %, about 1 to about 6 wt. %, about 1 to about 4 wt. % or about 1 to about 3 wt. % of the cellulose filaments.

The cellulose filaments can be any suitable cellulose filaments. For example, the cellulose filaments can be produced by the method disclosed in PCT Application Publication No. 2012/097446 A1 (High Aspect Ratio Cellulose Nanofilaments and Method for their Production). For example, the cellulose filaments can have an average length of about 200 μm to 2 mm, an average width of about 30 nm to 500 nm or about 50 to about 400 nm and/or an average aspect ratio of about 200 to 5000.

The fiber-reinforced BMC can also contain other cellulose fiber derivatives such as and not limited to cellulose nanofilaments (CNF) and nanocrystalline cellulose (NCC).

For example, the composition comprises untreated cellulose filaments.

For example, the composition comprises cellulose filaments in dry form.

For example, the composition comprises cellulose filaments that are individually separated, fluffed, opened and/or hammer milled.

For example, the composition comprises cellulose filaments that are chosen from softwood pulp and hardwood pulp.

For example, the cellulose filaments are obtained from NBSK cellulose filaments.

For example, the cellulose filaments have an average aspect ratio of from about 200 to about 5000.

For example, the cellulose filaments have an average width of from about 30 nm to about 500 nm.

The BMC filler composition can comprise one or more filler types such as for example clay, talc, calcium carbonate, aluminum trihydrate (ATH), magnesium hydroxide (MDH), hollow glass microspheres, exfoliated graphite nano-platelets and any other inorganic or organic fillers to impart specific attributes to BMC such as impact strength, compression molding and not limited to.

For example, the composition comprises about 30 to about 65 wt. %, about 45 to about 60 wt. %, about 50 to about 58 wt. % or about 55 to about 57 wt. % of the filler.

For example, the filler is chosen from calcium carbonate, clay, talc, aluminum trihydrate (ATH), magnesium hydroxide, hollow glass microspheres, exfoliated graphite nano-platelets, mica, wollastonite, barite, kaolin clay, ground silicate and calcined gypsum.

For example, the composition comprises about 20 to about 50 wt. %, about 25 to about 45 wt. %, about 28 to about 42 wt. %, about 30 to about 50 wt. %, about 30 to about 40 wt. %, about 20 to about 40 wt. %, about 25 to about 40 wt. %, or about 32 to about 38 wt. % of the resin.

The BMC resin can be selected among thermoset resins such as for example unsaturated polyesters, vinyl esters, epoxy or any resin, for example a thermoset resin, that can undergo a thickening step making it suitable for BMC. The BMC resin can also be selected from bio-based resins such as for example vegetable oils based resins and reinforced with wood pulp fibers to produce an ecological BMC.

For example, the resin is a thermoset resin.

For example, the resin is chosen from polyester, unsaturated polyester (UPE), vinyl ester (VE), vegetable oil based resin, epoxy and a thermoset resin that can undergo a thickening process.

The fiber-reinforced BMC according to this disclosure can also be a combination of wood pulp fibers or CF which are the principal reinforcing fibers (highest amount) with any other secondary fibers (smaller amount). However, in the partial fiberglass replacement of the reported studies, the natural fibers including wood pulp fiber can be used as secondary fibers (lower amount). In the present application, the secondary fibers can be chosen from and not limited to fiberglass, aramid, carbon and thermoplastic fibers. These latter can be used to impart specific attributes to BMC composite such as and not limited to impact and compression strengths.

For example, the composition further comprises reinforcing fibers.

For example, the cellulosic reinforcement acts as a primary reinforcement and the reinforcing fibers acts as a secondary reinforcement.

For example, the reinforcing fibers are in an amount lesser than an amount of the cellulosic reinforcement.

For example, the reinforcing fibers are chosen from fiberglass, carbon, aramid and natural fibers.

For example, the composition further comprises at least one additive.

A high temperature activated curing agent, internal mold release agent and thickening agent can also be used to produce wood fiber-reinforced BMC.

For example, the at least one additive is chosen from a curing agent, an internal mold release agent, a thickening agent, a low-profile additive, a colorant/pigment, a wetting agent, a dispersion agent and an air release agent.

For example, the composition comprises a curing agent that is chosen from tert-butyl peroxybenzoate (TBPB), benzoyl peroxide (BPO), tert.butylperoxy-2-ethyl hexanoate (TBPEH) and tert-amyl peroxy benzoate (TAPB).

For example, the composition comprises an internal mold release agent that is chosen from zinc stearate and calcium stearate.

For example, the composition comprises a thickening agent that is chosen from magnesium oxide, magnesium hydroxide, calcium oxide and calcium hydroxide.

For example, the composition comprises a low profile additive that is chosen from a thermoplastic, polyethylene, polystyrene, polyvinyl acetate and polycaprolactone.

For example, the composition, when cured, has a density of about 1.6 to about 1.80 g/cm³, about 1.65 to about 1.75 g/cm³, about 1.67 to about 1.72 g/cm³ or about 1.68 to about 1.70 g/cm³.

For example, the composition is an uncured composition.

For example, the composition is an uncured composition, optionally having a viscosity of about 5×10⁴ to about 10⁵.

For example, the composition is a cured composition.

For example, the composition is a cured composition in the form of a composite.

For example, the composition is obtained by injection molding, transfer molding or compression molding.

For example, the composition, when cured, has a tensile strength of about 38 to about 50 MPa or about 42 to about 48 MPa.

For example, the composition, when cured, has a flexural modulus of about 8 to about 13 GPa, about 8 to about 11 GPa, about 9 to about 13 GPa, about 9.5 to about 13 GPa, or about 10 to about 13 GPa.

For example, the composition, when cured, has a water absorption of about 0.2 to about 0.4% at day 1, at 23° C., according to ASTM D570-98 standard.

For example, the composition, when cured, has a water absorption of about 0.2 to about 0.35% at day 1, at 23° C., according to ASTM D570-98 standard.

For example, the composition, when cured, has a water absorption of about 0.2 to about 0.3% at day 1, at 23° C., according to ASTM D570-98 standard.

For example, the composition, when cured, has a water absorption of about 0.2 to about 0.25% at day 1, at 23° C., according to ASTM D570-98 standard.

For example, the composition, when cured, has a water absorption of about 0.6 to about 1% at day 7, at 23° C., according to ASTM D570-98 standard.

For example, the composition, when cured, has a water absorption of about 0.6 to about 0.9% at day 7, at 23° C., according to ASTM D570-98 standard.

For example, the composition, when cured, has a water absorption of about 0.6 to about 0.8% at day 7, at 23° C., according to ASTM D570-98 standard.

For example, the composition, when cured, has a water absorption of about 0.6 to about 0.7% at day 7, at 23° C., according to ASTM D570-98 standard.

For example, the composition is for use as a bulk molding compound (BMC) or in the manufacture of a BMC composite.

For example, the composition is for use in the manufacture of an automotive part, a building part or a part for construction sector, electrical sector or energy sector.

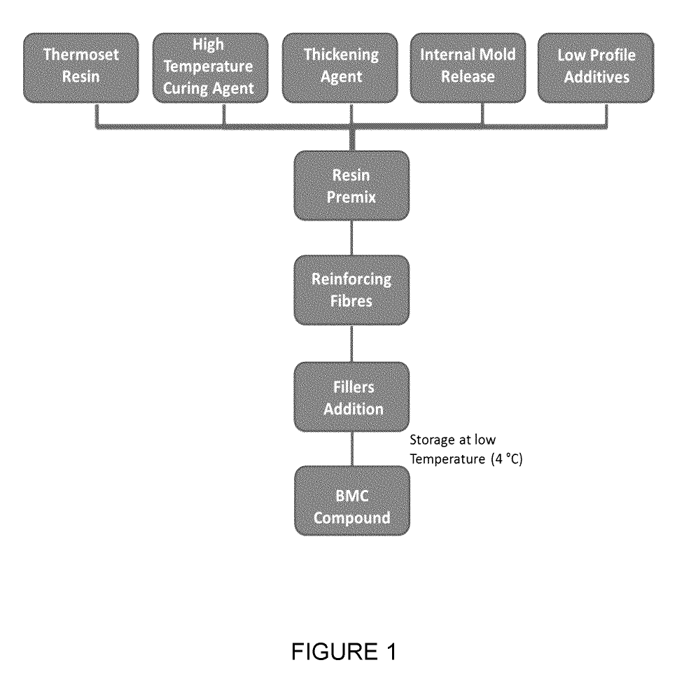

FIG. 1 shows a flow chart of how BMC is prepared industrially or in the laboratory. In the examples described herein, reinforcement fibers are either glass fibers or wood fibers. For example, the wood pulp fibers are prepared by the following steps and not limited to: pulp disintegration at low consistency to ensure a high level of fiber separation, dewatering by pressing, fluffing, drying at room temperature, and an opening step with a fluffer or fiber opener. The drying of wood pulp fibers can also be carried out at high temperature using, for example, flash drying. For example, wood pulp fibers can also be hammer milled such as in the case of fluff pulp, dry lap, pulp bale or freeze dried after disintegration only in the case of cellulose filaments and not limited to.

Also provided herein in another aspect is a method of using of the composition herein described, the method comprising placing the composition in a mold and subjecting the composition to heat and/or pressure.

For example, the composition is subjected to injection molding, transfer molding or compression molding.

For example, the method further comprises mixing the resin with the at least one additive prior to mixing the resin with the cellulosic reinforcement.

For example, the method further comprises mixing the first mixture with reinforcing fibers prior to mixing with the filler.

For example, the method further comprises individually separating, fluffing, opening and/or hammer milling the cellulosic reinforcement prior to mixing with the resin.

For example, the second mixture is matured at a temperature of about 20° C. to about 30° C., about 22° C. to about 28° C. or about 23° C. to about 27° C.

For example, the second mixture is matured under humidity of about 20% to about 50% or about 30% to about 40%.

For example, the second mixture is matured for about 1 day to about 2 days or about 3 days to about 6 days or about 4 days to about 5 days.

For example, the second mixture is stored at a temperature of about 2° C. to about 8° C. or about 3° C. to about 6° C.

For example, the composition is cured at a temperature of about 100° C. to about 200° C., about 120° C. to about 180° C., about 130° C. to about 170° C., or about 140° C. to about 160° C.

For example, the composition is cured at a pressure of about 250 psi to about 2500 psi, about 250 psi to about 2000 psi, about 250 psi to about 1500 psi or about 250 psi to about 1400 psi.

For example, the composition is cured for about 2 seconds to about 1 minute, about 5 seconds to about 1 minute, about 10 seconds to about 1 minute, about 1 minute to about 3 minutes, about 5 minutes to about 30 minutes, about 5 minutes to about 25 minutes, about 5 minutes to about 20 minutes or about 5 minutes to about 15 minutes.

For example, the curing comprises submitting the composition to injection molding.

For example, the curing comprises submitting the composition to transfer molding.

For example, the curing comprises submitting the composition to compression molding.

For example, the second mixture that is matured comprises a resin chosen from polyester, unsaturated polyester (UPE), vinyl ester (VE) and vegetable oil based resin.

The below presented examples are non-limitative and are used to better exemplify the processes of the present disclosure.

### EXAMPLES

### Example 1

Examples of the different BMC components are summarized in Table 1.

TABLE 1
Typical components of commercially available BMC.
Bulk Molding Compoundimal

| | Optimal | |
|---|---|---|
| Component | weight % | Examples |
| Resin | 25 to 35% | Polyester, vinyl ester, epoxy, vegetable oils |
| | | based resin, any thermoset resin suitable |
| | | for a thickening process |
| Fillers | 20 to 65% | Calcium carbonate, clay, talc, alumimuim |
| | | trihydrate (ATH), magnesuim hydroxide |
| | | (MDH) |
| Fibers | 10 to 25% | Fiberglass, carbon, aramid, wood pulp or |
| | | natural fibers (hemp, flax, kenaf, jute etc.) |
| High | 1 to 2% | Tert-butyl peroxybenzoate (TBPB), benzoyl |
| temperature | | peroxide (PBO), tert.butylperoxy-2-ethyl |
| curing agent | | hexanoate (TBPEH) |
| Release | 0.5 to 2% | Zinc stearate and calcium stearate |
| agent | | |
| Low profile | 7 to 20% | Thermoplastic including polyethylene, |
| additives | | polystyrene, polyvinyl acetate, |
| | | polycaprolactone |
| Thickening | 1 to 3% | Oxides or hydroxides of magnesium or |
| agent | | calcium MgO, Mg(OH) 2 |

### Example 2

The presently disclosed untreated wood pulp fiber or CF-reinforced BMC preparation is as follows (as shown in FIG. 1): the BMC resin and curing agent are mixed first under low agitation followed by the addition of a mold release agent and a thickening agent and premixed for about 5 min at low speed. The premix is introduced in the sigma blade mixer and stirred slowly at about 80 rpm; opened wood pulp fibers are then progressively added first to the premix to ensure sufficient fiber impregnation and wettability by the resin, the mixer speed is adjusted accordingly. Fillers are then introduced progressively and mixed for about 5 to about 10 minutes. The BMC compound that is produced and matured is then stored at a temperature of approximately 4° C. for about 3 to about 4 days to allow time for the thickening process. After maturation, the wood pulp fiber- or CF-reinforced BMC compound has a compound viscosity which corresponds to a tack-free material which is easy to handle and process by compression molding.

Previous known wood fibers are pretreated to render them more hydrophobic and more compatible with the resin. An aspect of the present invention relates to the use of untreated pulp fiber. Another aspect of the present invention relates to the opening of the pulp fiber prior to use. Opened wood pulp fibers possess a high exposed specific surface area that allows an increased fiber networking in the compound and allows a complete and uniform wetting of the fibers or filaments by the resin. With higher specific area of the cellulose filaments or opened wood pulp fibers, the BMC compound viscosity can be attained after premixing of the different components, even at very low levels of fiber addition in the order of about 1% to about 8% by weight. The high specific area also allows the formation of uniform and strong fiber networks which in turn improve the mechanical properties of the BMC composite. The high surface area of the opened fibers constitutes a key element for the improved performance of wood pulp fiber or CF as reinforcing fibers in BMC composites. Such opening of the fibers also means that less wood fiber is needed to reinforce the BMC. Previous studies using wood or natural fibers without fiber opening at higher contents have been shown to be detrimental to fiber reinforcement performance in BMC.

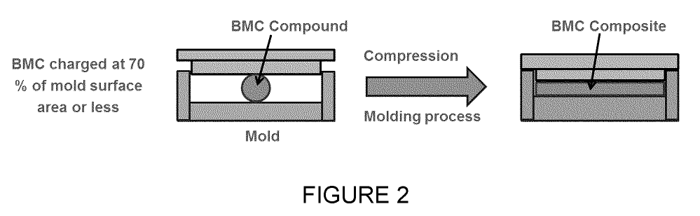

The resulting BMC compound is subjected to heat and pressure during compression molding process to produce BMC composite. The BMC compound is charged at about 70% of mold surface area or less, as shown in FIG. 2. The BMC compound has a flow behaviour similar to that of fiberglass reinforced BMC compound, thus allowing the material to flow through the mold cavities to produce the final BMC composite parts. Adequate flowability is critical for any reinforcing fiber to be used in BMC process. Accordingly, a fiber loading percentage that is too great may be detrimental to BMC compound viscosity and flowability. Wood pulp fiber or CF-reinforced BMC have properties similar to those of commercially available glass fiber reinforced BMC in terms of strength, stiffness and water absorption.

The replacement of fiberglass having a density of 2.6 g/cm³ in BMC composites with low density wood pulp fibers or CF having a density of 1.5 g/cm³ can lower the overall BMC density, thereby resulting in lighter weight parts.

In one embodiment, the untreated wood pulp fiber-reinforced BMC composites are suitable to produce complex parts for a variety of applications in various sectors such as but not limited to automotive, building, construction, electrical and energy.

### Example 3

The BMC is made by a complete replacement of the fiberglass component (about 15 wt %) as typically used in a commercial BMC formulation with untreated wood pulp fibers or CF at lower weight percentages (about 2 to about 5.2 wt %) and containing up to about 57% filler by weight.

The BMC reference formulation indicated in phr (part per hundred resin) is as follows:

| | |
|---|---|
| Resin | 100 |
| Fillers | 150 |
| Curing agent | 2 |
| Thickening agent | 2 |
| Mold release agent | 3 |
| Fibers (fiberglass) | 45 |

The fiberglass (fiber length=½ inch) is sized for specific use in polyester resins. The fiberglass binder dissolves in the solvent present in the polyester resin (styrene) allowing for complete fiber wettability by the resin. The resin used is a BMC unsaturated polyester resin which was first mixed with the curing agent (tert-butyl peroxybenzoate, TBPB). The thickening agent and mold release agent were respectively magnesium oxide (MgO) and INT 626B. The filler in these compositions was a calcium carbonate (CaCO₃). The compositions of the BMC reference and wood pulp fiber or CF-reinforced BMC composites are shown in Table 2. The final BMC were made by compression molding using a mold and a hot press at about 150° C. for about 10 minutes at about 300 psi to produce BMC materials for testing.

TABLE 2
Compositions of reference fiberglass BMC and wood pulp fiber-
reinforced BMC.

| | Fiberglass - | | | |
|---|---|---|---|---|
| | BMC | NBSK - | | |
| Parameters | Reference | BMC | SBSK - BMC | CF - BMC |
| Fibers (wt %) | 15.0 | 5.2 | 5.2 | 2.0 |
| Resin (wt %) | 33.1 | 36.9 | 36.9 | 38.1 |
| Fillers (wt %) | 49.6 | 55.3 | 55.3 | 57.2 |
| Other Additives* | 2.3 | 2.6 | 2.6 | 2.7 |
| (wt %) | | | | |
| Opening Method | N.A. | F | F or HM | F |

*Other additives include curing agent, internal mold release agent, thickening agent and low profiles additives.
F = fluffed;
HM = hammer milled

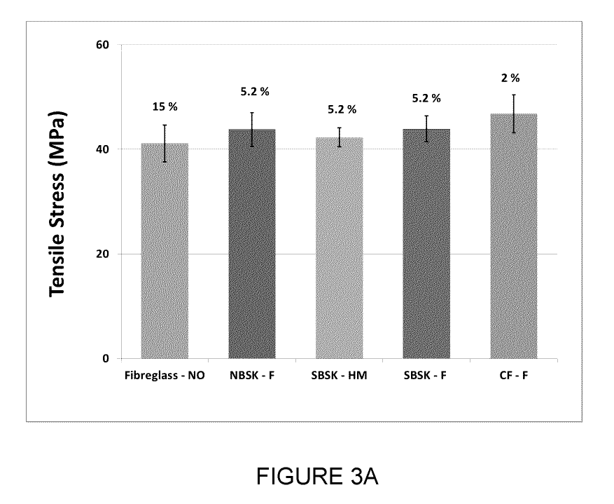

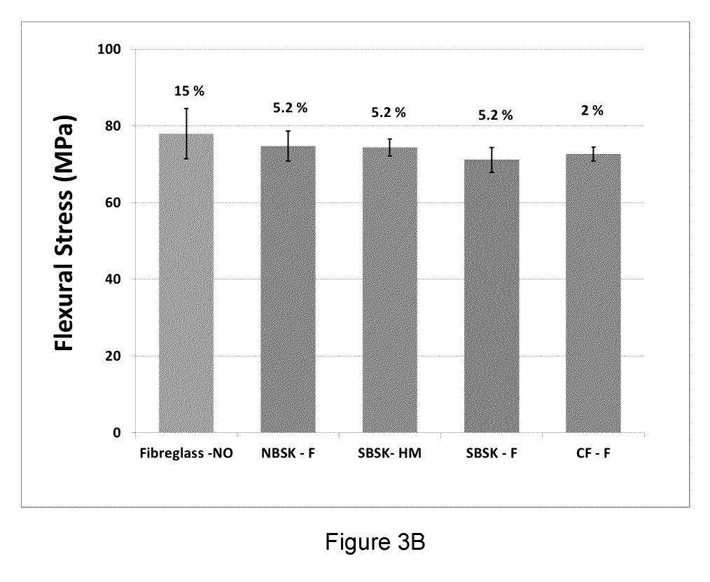

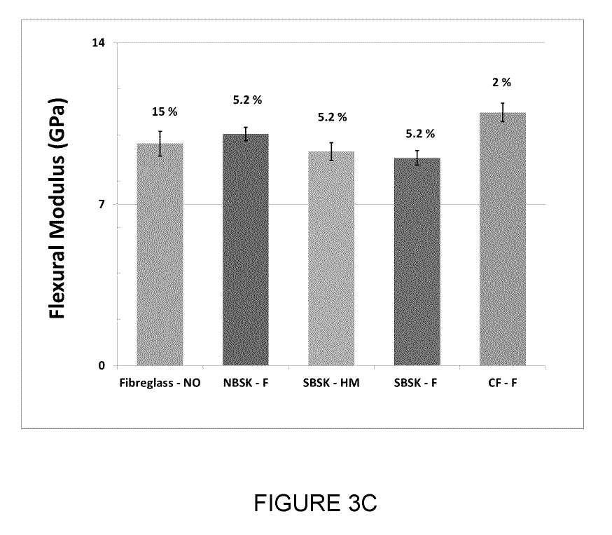

Tensile, flexion and water absorption properties were measured on all the untreated wood pulp fiber or CF-reinforced BMC samples and compared against the fiberglass-reinforced BMC reference. The results indicated that wood pulp fiber or CF-reinforced BMC samples are similar to fiberglass BMC in terms of tensile strength, flexural strength and flexural modulus (FIG. 3 a-c). However, the fiber loading levels in the biofiber reinforced BMC's were 2.8 to 7.5 times lower than fiberglass reinforced BMC (see Table 2). The fiber-reinforced BMC composites herein described present mechanical properties (tension and flexion) similar to values reported in the literature. Furthermore, the performances of these fiber-reinforced BMC's are similar to commercially available BMC composites (see BMC composite in Technical Design Guide for FRP Composite Products and Parts, Molded Fiber Glass Companies).

Contrary to previous reports of natural fiber-reinforced BMC comprising a filler content below 25 wt %, the opened and untreated wood pulp fiber-reinforced BMC can comprise up to about 57 wt % filler.

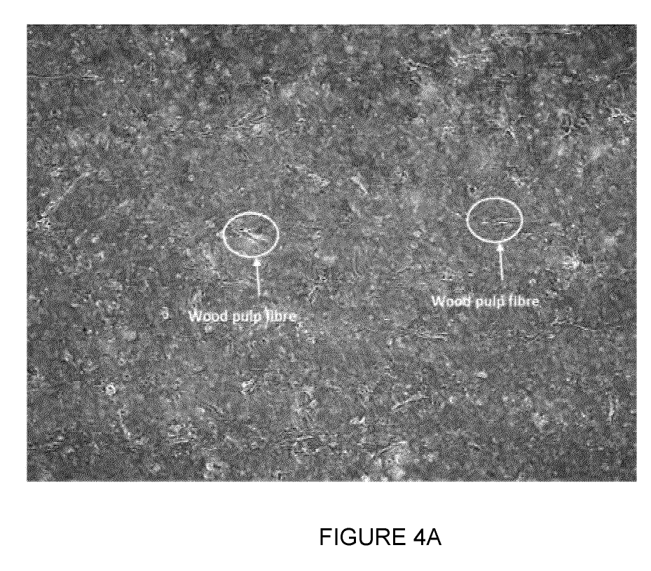

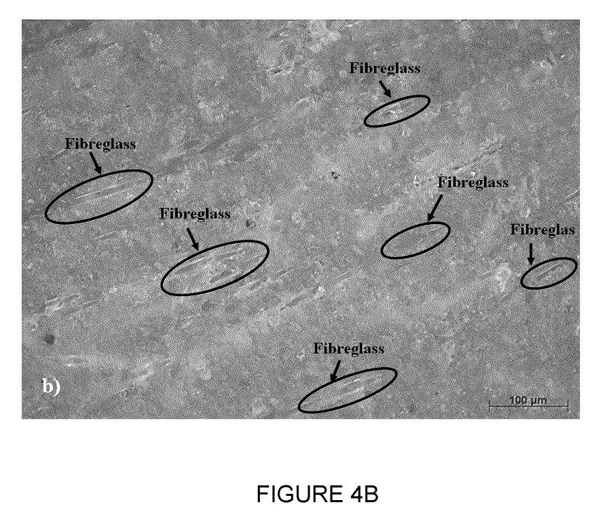

Due to their higher specific surface area compared to wood pulp fibers, cellulose filament-reinforced BMC samples provide good mechanical properties even at very low fiber loading of 2 wt %, when compared to 15% reinforcement fibers typically used in commercial BMC. FIG. 4 a-b presents a comparison between wood pulp fiber and fiberglass BMC composites by optical microscopy. The wood pulp fiber exhibits a uniform dispersion in BMC with a high fiber networking (FIG. 4 a) which is responsible for the good wood pulp fiber-reinforced BMC mechanical properties. However, the fiberglass in BMC (FIG. 4 b) is unevenly dispersed, as shown by the black rings, and exhibits poor fiberglass networking.

The presently disclosed untreated wood pulp fiber or CF-reinforced BMC composites have low water absorption values of approximately about 30 to about 40% less than those observed for fiberglass reference samples after a 1-day test. Furthermore, after 7-day tests, the fiber-reinforced BMC composites have water absorption values of about 20% to about 40% lower than a fiberglass BMC sample (see Table 3). Further, the presently described wood pulp fibers or Cellulose filament do not require any pre-treatment prior to their use in BMC in order to provide good water resistance.

TABLE 3
Water absorption % of fiberglass BMC reference and wood pulp
fiber or CF-reinforced BMC composites (ASTM D570-98)

Water Absorption
(%) at 23° C. -
ASTM D570-98

| BMC Samples | 1 Day | 7 days |
|---|---|---|
| Fiberglass | 0.42 | 1.12 |
| NBSK | 0.28 | 0.84 |
| SBSK disintegrated | 0.29 | 0.88 |
| SBSK hammermilled | 0.25 | 0.8 |
| CF | 0.22 | 0.66 |

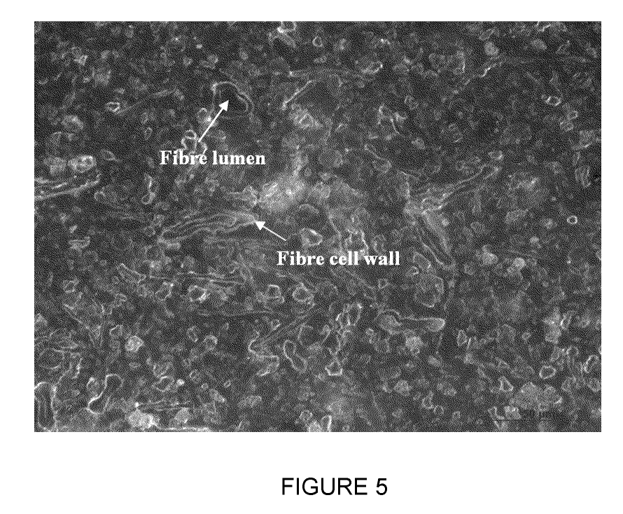

Three principal factors are responsible for the high water resistance of the wood pulp fiber or CF-reinforced BMC's: a) very small amount of fibers in BMC (about 2 to about 5.2 wt %) compared to values cited in the literature; b) a long maturation step of about 3 to about 4 days that allows a high level of fiber wettability and impregnation by the resin which prevents water uptake and c) highly individualized wood pulp fibre or CF that facilitate cellulose fibre wettability and impregnation by the resin Optical microscopy images show that untreated wood pulp fibers in reinforced BMC, show fiber lumens well-filled by the resin (FIG. 5).

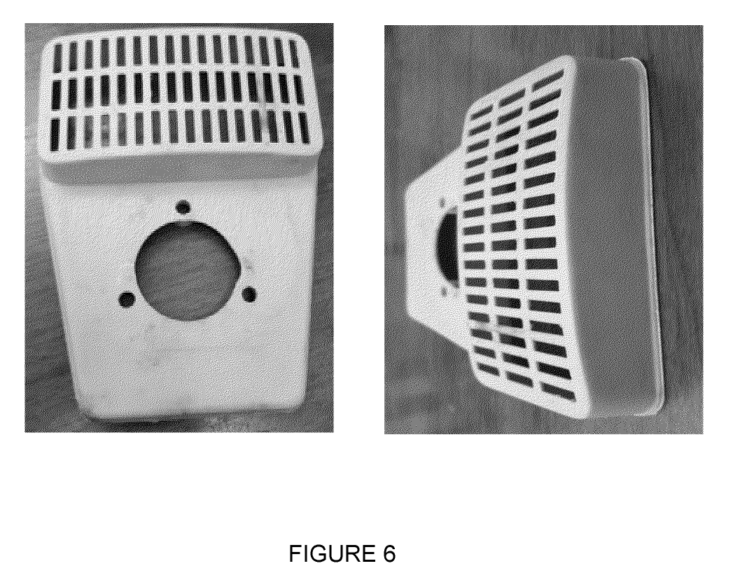

The presently disclosed untreated wood pulp fiber or CF-reinforced BMC composites have a dielectric properties compared to commercial fibreglass-reinforced BMC as shown in Table 4. Furthermore, the presently described wood pulp fiber or CF-reinforced BMC does not need any changes to be processed by transfer molding process. The cellulose-reinforced BMC have shown an excellent flow capacity during transfer molding process allowing manufacturing cellulose-reinforced BMC 3D parts (FIG. 6).

TABLE 4
Comparison of dielectric strength properties (step-by-step or
short-time) in KV/mm of fibreglass reinforced-BMC (commercial/FPI)
and cellulose fibre reinforced-BMC.

| | Fiberglass-Reinforced | | Cellulose-Reinforced | |
|---|---|---|---|---|
| | BMC | | BMC | |
| | Commercial | | Wood Pulp | Cellulose |
| | BMC | FPI-BMC | Fibre | Filament (CF) |
| Properties | 15 to 25 wt. % | 15 wt. % | 5.2 wt. % | 2 wt. % |
| Dielectric | 13.4-14.6 | 11.2-11.8 | 11-13.1 | 12.3-13.4 |
| Strength | | | | |
| Step-by-Step | | | | |
| (KV/mm) | | | | |
| Dielectric | 12.4-16.5 | 13.4-14.5 | 13.3-14.3 | 13.2-14 |
| Strength | | | | |
| Short time | | | | |
| (KV/mm) | | | | |

### REFERENCES

Polymer Blends, Volume 2, D.R. Paul, Academic Press Inc (1978).
O. Owolabi et al., Coconut-fiber-reinforced thermosetting plastics, Journal of Applied Polymer Science, vol. 30, 1985.
Molded Fiber Glass Companies, BMC composite in Technical Design Guide for FRP Composite Products and Parts,

1. (canceled)

2. A composition comprising:
a thermosetting resin;
about 0.5 to about 15 wt. % of a cellulosic reinforcement, wherein said cellulosic reinforcement is chosen from wood-pulp fibers and cellulose filaments and a mixture thereof; and
a filler;
wherein said composition, when cured, has a density of less than about 1.85 g/cm³.

3. (canceled)

4. A composition comprising:
a thermosetting resin;
a cellulosic reinforcement, wherein said cellulosic reinforcement is chosen from wood-pulp fibers and cellulose filaments and a mixture thereof; and
about 30 to about 65 wt. % of a filler;
wherein said composition, when cured, has a density of less than about 1.85 g/cm³.

5-7. (canceled)

8. A composition comprising:
a thermosetting resin;
about 0.5 to about 15 wt. % of a cellulosic reinforcement, wherein said cellulosic reinforcement is chosen from wood-pulp fibers, cellulose filaments and a mixture thereof; and
a filler;
wherein said composition, when cured, has a water absorption of less than 0.4% at 1 day, at 23° C., according to ASTM D570-98 standard and/or a water absorption of less than 1% at day 7, at 23° C., according to ASTM D570-98 standard.

9. The composition of claim 3, wherein said composition comprises about 0.5 to about 15 wt. % of said cellulosic reinforcement.

10. The composition of claim 2, wherein said composition comprises about 0.5 to about 10 wt. % of said cellulosic reinforcement.

11. The composition of claim 2, wherein said composition comprises about 30 to about 65 wt. % of said filler.

12. The composition of claim 4, wherein said composition comprises about 35 to about 65 wt. % of said filler.

13. The composition of claim 2, wherein said filler is chosen from calcium carbonate, clay, talc, aluminum trihydrate (ATH), magnesium hydroxide, hollow glass microspheres, exfoliated graphite nano-platelets, mica, wollastonite, barite, kaolin clay, ground silicate and calcined gypsum.

14. The composition of claim 2, wherein said composition comprises about 1 to about 15 wt. % of said wood-pulp fibers.

15. The composition of claim 4, wherein said composition comprises about 0.5 to about 15 wt. % of said cellulose filaments.

16. The composition of claim 2, wherein said composition comprises about 20 to about 50 wt. % of said thermosetting resin.

17. The composition of claim 2, further comprising reinforcing fibers that are chosen from fiberglass, carbon, aramid and natural fibers.

18. The composition of claim 2, wherein said composition, when cured, has a density of about 1.6 to about 1.85 g/cm³.

19. The composition of claim 2, wherein said composition, when cured, has a tensile strength of about 38 to 50 M Pa and has a flexural modulus of about 8 to 13 GPa.

20. (canceled)

21. The composition of claim 2, wherein said composition comprises wood-pulp fibers or cellulose filaments that are individually separated, fluffed, opened and/or hammer milled.

22. (canceled)

23. The composition of claim 2, wherein said thermosetting resin is chosen from polyester, unsaturated polyester (UPE), vinyl ester (VE), vegetable oil based resin, epoxy and a thermosetting resin that can undergo a thickening process.

24. The composition of claim 2, wherein said composition is an uncured composition.

25. The composition of claim 2, wherein said composition is a cured composition in the form of a composite.

26-27. (canceled)

28. A method of using of the composition of claim 2, said method comprising placing said composition in a mold and subjecting said composition to heat and/or pressure.

29-32. (canceled)

33. A method of manufacturing a BMC composite, comprising:
obtaining a composition as defined in claim 2; and
submitting said composition to conditions suitable for curing said composition so as to obtain a BMC composite.

34. (canceled)
